(19) United States
(12) Patent Application Publication
(10) Pub. No.: US 2012/0066051 A1
(43) Pub. Date: Mar. 15, 2012

(54) SYSTEM AND METHOD FOR MANAGING A PROOF OF PURCHASE REWARD PROGRAM

(75) Inventors: Cheryl BLACK, San Francisco, CA (US); Ajay AMLANI, Burlingame, CA (US); Tennile V. GOFF, Springfield, VA (US); Daniel J. CORWIN, Canonsburg, PA (US)

(73) Assignee: YOU TECHNOLOGY, INC., Delray Beach, FL (US)

(21) Appl. No.: 13/233,801

(22) Filed: Sep. 15, 2011

Related U.S. Application Data
(60) Provisional application No. 61/382,993, filed on Sep. 15, 2010.

(51) Int. Cl. G06Q 30/00

(52) U.S. Cl. 705/14.33

(57) ABSTRACT

A system and method for providing consumer, vendors, manufacturers, reward program providers, and reward program beneficiaries with mechanisms for managing and participating in a reward program. By associating consumer identifiers with reward programs, a reward program manager mechanism may administer a reward program on the behalf of all participants.

### CLAIM OF PRIORITY

This application claims priority under 35 U.S.C. §119(e) to U.S. Provisional Application No. 61/382,993, filed Sep. 15, 2010, which is incorporated herein by reference in its entirety for all purposes.

### BACKGROUND

The disclosed embodiments pertain to reward programs and, more specifically, to systems and methods for enabling consumers to participate in a reward program in an automatic, electronic manner.

Proof of purchase (POP) reward programs enable consumers to collect POPs (e.g., product Universal Product Codes (UPCs), labels, box tops, promotional codes, etc.) and send them to a sponsor of a reward program (referred to herein as “sponsor”). Once the sponsor receives the POPs, the sponsor provides a beneficiary, such as the consumer or another entity, with a benefit, such as a monetary or material reward.

This process is cumbersome for both the consumer and the sponsor. When shopping, the consumer must remember which goods and/or services (herein referred to as “products”) are valid for the program. Once he has purchased these products, the consumer must cut the POPs from the packages, collect them until he has obtained a sufficient amount necessary for redemption, and send them to the sponsor. In cases when the consumer is not the beneficiary, the consumer may need to provide the POPs to the beneficiary, which in turn sends them to the sponsor. The sponsor must then allot appropriate resources so that it may count the received POPs, confirm their validity, determine their benefit value, determine the appropriate beneficiary, and notify the beneficiary of the benefit.

The situation is further complicated if a consumer wishes to participate in multiple reward programs. The consumer must track which products are valid for which particular program, sort and track POPs for each program, and ensure that the appropriate POPs are sent to the appropriate sponsor. This is a great deal of work for the consumer and often dissuades consumers from participating in such programs or utilizing them to their full potential.

What is needed is a system and method for providing a convenient manner for a consumer to participate in one or more POP reward programs. More particularly, what is needed is a system and method that enables a consumer to participate in a POP reward program via an electronic means and without the need for action subsequent to the purchase transaction.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The present invention addresses the aforementioned needs by providing consumers, sponsors, vendors, manufacturers, reward program providers and reward program beneficiaries with an accessible system and a convenient method for managing and participating in POP reward programs. By associating consumer identifiers with a reward program, a reward program manager mechanism may administer the reward program on the behalf of all participants.

In an embodiment, a system for managing a proof of purchase reward program may include a vendor mechanism configured to administer a transaction conducted between a vendor and a consumer; a reward program sponsor mechanism configured to transmit reward program data associated with a reward program; a beneficiary mechanism configured to receive benefit data and provide a beneficiary with a benefit identified by the received benefit data; a consumer access mechanism configured to allow a consumer to register a consumer identifier for a reward program offered by a reward program sponsor, wherein registering the consumer identifier enables the consumer to participate in the reward program when conducting a transaction with a vendor via the vendor mechanism; and a reward program manager mechanism configured to manage transmission of data between the vendor mechanism, the reward program sponsor mechanism, the beneficiary mechanism, and the consumer access mechanism, manage one or more of consumer data, reward program sponsor data, product data, reward program data, beneficiary data, and vendor data, manage a determination of whether transactional data containing a consumer identifier complies with a reward program parameter, and provide the beneficiary mechanism with benefit data if the transactional data containing the consumer identifier complies with the reward program parameter.

In an embodiment, a method for managing a proof of purchase reward system may include receiving transactional data gathered from a transaction occurring at a vendor system; analyzing the transactional data by identifying a consumer identifier associated with a consumer conducting the transaction and a product identifier associated with a product in the transactional data; identifying the consumer as a participating consumer in response to the consumer identifier matching one of a plurality of consumer identifiers associated with a reward program; identifying the product as a reward program product in response to the product identifier associated with the product being associated with the reward program; in response to identifying a reward program product and a participating consumer in the transactional data, determining a benefit due to a beneficiary in response to the transaction satisfying a reward program parameter; and issuing a reward to the beneficiary in response to the reward program parameter being satisfied.

In an embodiment, a method for an electronic proof of purchase reward program may include receiving, at a vendor system from a reward program manager mechanism, reward program data including a product identifier for a product included in a reward program; creating, at the vendor system, a tracking code for the product identifier that enables a transactional mechanism of the vendor system to mark the product as a reward program product during a transaction; identifying the reward program product during a transaction at the transactional mechanism by detecting the presence of a product identifier associated with the reward program; marking the product identifier with a tracking code at the transactional mechanism; storing transactional data, including a product identifier marked with a tracking code, associated with the transaction; filtering the stored transactional data by extracting transactional data associated with the tracking code; and transmitting the filtered transactional data to the reward program manager mechanism, which is enabled to reward a beneficiary based upon the filtered transactional data.

### BRIEF DESCRIPTION OF THE DRAWINGS

Aspects, features, benefits and advantages of the present invention will be apparent with regard to the following description and accompanying drawings, of which:

FIG. 1 depicts a component architecture of an exemplary reward program management system according to an embodiment;

FIG. 2 depicts an architecture overview of an exemplary reward program manager mechanism according to an embodiment;

FIG. 3 depicts a flowchart of an exemplary process of a consumer enrolling with a reward program manager mechanism according to an embodiment;

FIG. 4 depicts a flowchart of an exemplary process in which a reward program manager mechanism manages a reward program according to an embodiment;

FIG. 5 depicts a flowchart of an exemplary process in which a reward program manager mechanism manages a reward program involving promotional codes enhanced by use of a consumer identifier according to an embodiment; and

FIG. 6 depicts a block diagram of exemplary internal hardware that may be used to contain or implement program instructions according to an embodiment.

### DETAILED DESCRIPTION

Various embodiments of the invention are discussed in detail below. While specific implementations are discussed, this is done for illustration purposes only. A person of ordinary skill in the relevant art will recognize that other components and configurations may be used without departing from the spirit and scope of the invention.

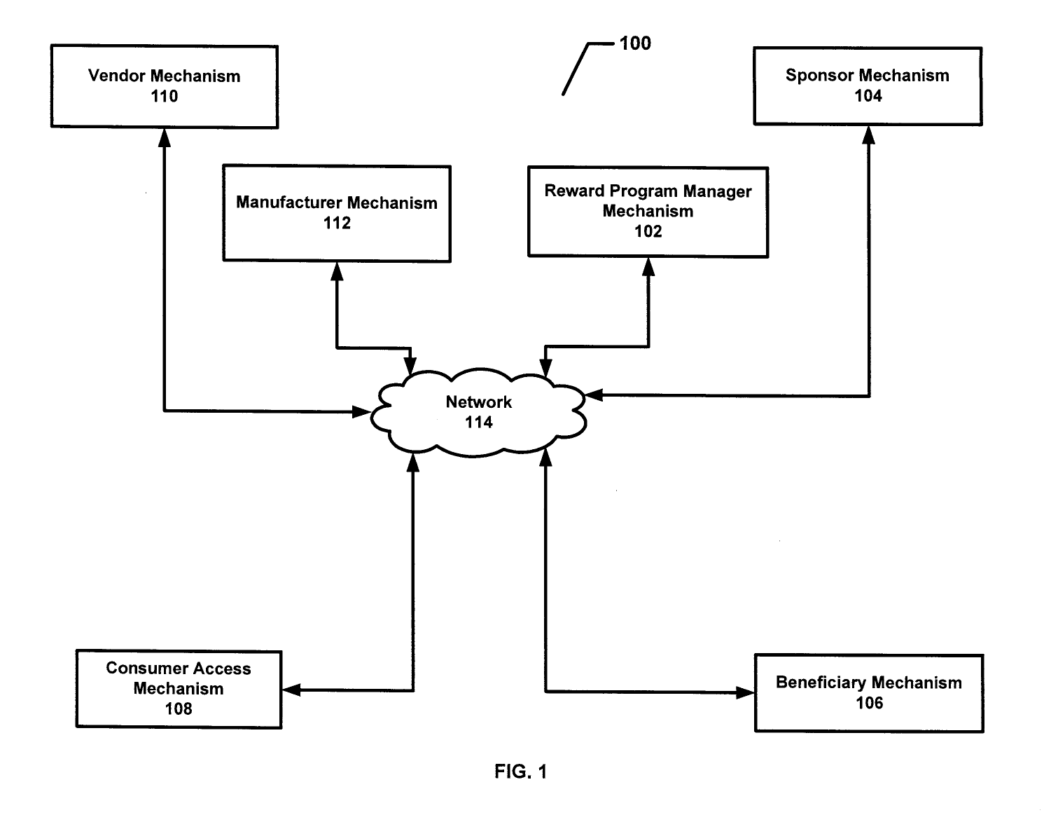

The system depicted by FIG. 1, referred to herein as reward program management system (RPMS) 100, enables convenient, electronic processes by which consumers and vendors may easily participate in a reward program offered by a sponsor. To participate in a reward program, a consumer may purchase one or more particular products and verify to the sponsor that he has purchased such products. Once the sponsor has confirmed the purchases, it may contribute a benefit, typically based upon the value and/or quantity of what the consumer purchased, to a beneficiary, which may be the consumer or another entity. RPMS 100 may enable a consumer to participate in one or more reward programs electronically, thereby eliminating the need for the consumer to take any action after purchasing the appropriate product(s) (e.g., submitting POPs manually). RPMS 100 may enable the electronic collection of transactional data, thereby enabling automatic tracking of products that a consumer has purchased, automatic determination of whether the associated transactional data includes a product associated with a reward program and, if so, automatic determination of whether a benefit is due.

Additionally, RPMS 100 may function in parallel with a traditional POP program. For example, a sponsor may allow consumers to mail POPs to the sponsor's redemption center and receive benefits in the traditional fashion as well as employ an automatic program, such as a program implementing one or more of the processes described herein. This may allow a beneficiary to benefit doubly from the sponsor's programs. The sponsor may maintain the traditional POP program separately from the automatic program, and the consumer, and respective beneficiary, may receive the associated benefits independently (i.e., via the traditional program and via the automatic program). Alternatively, the sponsor may associate its traditional POP program with an automatic program. For example, a consumer may be requested to submit a consumer identifier, such as a shopper card or email address, when submitting his POP in the traditional fashion. When the sponsor receives this POP material, it may extract the consumer identifier and cross reference it with consumer identifiers of users of the automatic program. If a match is found, it may credit the beneficiary with rewards based upon the traditional POPs in addition to any rewards based on an electronic process. Conversely, this may function in reverse, and POPs received electronically may be used to add a benefit to a traditional POP account.

In one embodiment, such duplicative reward program procedures may be restricted to a particular vendor, thereby allowing the vendor to offer this procedure in order to obtain a competitive advantage over its competitors. For example, while two grocery store chains may participate in a particular POP program (e.g., both sell the same participating products), only one grocery store chain may participate with RPMS 100 and enable automatic POP procedures in addition to traditional ones.

Alternatively, a sponsor may prevent duplicative rewards by cross-referencing consumer information in order to prevent a duplicative reward for the same purchase. For example, reward program manager mechanism (RPM) 102 and/or sponsor mechanism 104 may cross-reference a mailing address received with mailed-in POP information with consumer mailing addresses on file with the automatic program and ensure that a consumer is credited only once for each transaction.

RPMS 100 may include RPM 102, sponsor mechanism 104, beneficiary mechanism 106, consumer access mechanism 108, vendor mechanism 110, and manufacturer mechanism 112. Each of the RPM 102, sponsor mechanism 104, beneficiary mechanism 106, consumer access mechanism 108, vendor mechanism 110, and manufacturer mechanism 112, may include a computer processor, electronic components, such as a tangible storage medium, such as a physical memory, RAM, ROM, EPROM, CD, DVD, Blu-ray® disc or the like, a server, a database or the like, which may be used for processing, transmitting and/or receiving information. Each portion of RPMS 100 may interact with other components of RPMS via network 114. Network 114 may include the Internet, an intranet or any other private or proprietary network and may include local area networks (LANs), wireless local area networks (WLANs), wide area networks (WANs), mobile networks, or the like.

RPM 102 may be a computer mechanism that enables consumers, vendors, sponsors, manufacturers, and beneficiaries to interact with one another. Each of the aforementioned entities may register with RPM 102 in order to participate in RPMS 100. An entity may initiate participation in RPMS 100 by contacting the RPM service provider via a Web site, via mail, via email, over the phone, or the like. In one embodiment, an independent instance of RPMS 100 may be implemented for each reward program employing the RPM service provider's services. For example, one sponsor may not wish to have its program associated with a competing sponsor's program. Alternatively, one or more sponsors may be managed and maintained via the same instance of RPMS 100. If RPMS 100 maintains one or more reward programs, RPM 102 may allow a consumer to interact with more than one reward program via the same consumer account. Alternatively, RPM 102 may compartmentalize one or more reward programs so that data for each program is maintained separately. RPM 102 may associate data from a particular program with a program identifier, such as a program marker or other reference, in order to differentiate reward program data. This may enable RPM 102 to maintain separate reward program records for the same consumer (i.e., a reward program account for each reward program in which a consumer has enrolled).

In one embodiment, a consumer may access RPM 102 via consumer access mechanism 108, which may be a computing device, such as a personal computer, a mobile device (e.g., mobile phone, smart phone, personal digital assistant, etc.), a kiosk, or the like. A consumer may register personal information (e.g., name, mailing address, email address, etc.), demographic information (e.g., age, income level, etc.), one or more consumer identifiers, or the like. A consumer identifier may be any data that may be employed to identify the consumer throughout RPMS 100, such as a shopper card number, a financial account number (e.g., a credit card number), a phone number, an identification number (e.g., a driver's license number), biometric data (e.g., a consumer's fingerprint), an email address, or the like. Additionally, the RPM 102 may assign a consumer identifier and this assigned identifier may or may not be shared with the consumer (e.g., it may not be shared if it is used for internal purposes only). A consumer's registered information may be maintained in a consumer account which may be referenced by one or more consumer identifiers. A consumer may enroll in a reward program via the sponsor, the beneficiary, the manufacturer, vendor, and/or the RPM service provider. As mentioned, RPMS 100 may be implemented on an individual reward program basis and may enable the functionality of a sole reward program. If RPMS 100 is configured to allow for multiple reward programs to run in a segregated fashion, a program identifier, such as a program marker, may be associated with the consumer account to differentiate the account from the consumer's other reward program accounts (if any). Alternatively, RPMS 100 may be enabled to allow a consumer to access multiple sponsors and their programs jointly and a consumer may associate multiple reward programs with one consumer account. As such, multiple program identifiers, such as program markers, may be associated with the same consumer account.

A sponsor may be an entity, such as an organization or individual, which offers a program that enables a consumer to contribute to a beneficiary, such as the consumer himself or another entity. Sponsor data may be maintained by RPM 102 for the participating sponsor. Sponsor data may include data pertaining to one or more reward programs that the sponsor is offering. A reward program may be associated with a program marker, which may be used as a reference to ensure accurate tracking and implementation of a particular reward program throughout RPMS 100. A program marker may be a code used as a reference by one or more RPMS 100 components. For example, a reward point program may be identified by the program marker “RWDPT01.” In one embodiment, a program marker may be used as a program identifier and may be employed to distinguish data associated with one reward program from another program. In another embodiment, a separate program identifier may be used for this purpose. Sponsor data may also include contact information (e.g., sponsor representative's name, phone number, email address, etc.) and data indicating the particulars of the reward program, such as participating products and/or their product identifiers (e.g., UPCs, names, etc.), one or more participating beneficiaries, one or more reward program parameters, or the like. Furthermore, sponsor data may include any data needed to ensure that sponsor mechanism 104 may interact with RPM 102. Sponsor mechanism 104 may include a computer mechanism that enables reward program processes associated with the sponsor.

RPM 102 may also maintain manufacturer data, which may comprise data indicating a reward program that includes the manufacturer's products. For example, manufacturer data may include a product identifier for each of a manufacturer's reward program products. “Product” as used herein includes a good or service offered by a manufacturer or a vendor to a consumer. Manufacturer data may also include contact information and any data needed to ensure that manufacturer mechanism 112 may interact with RPM 102. Manufacturer mechanism 112 may include a computer mechanism that enables reward program processes associated with the manufacturer. In some scenarios, a manufacturer may also manage a reward program and/or may be the program's sponsor or closely affiliated with the sponsor. In this case, rather than interact with RPM 102 directly, the manufacturer may employ sponsor mechanism 104 to do so.

Vendor data may also be maintained by RPM 102 for the participating vendor. Vendor data may include vendor contact information and any data needed to ensure that vendor mechanism 110 may interact with RPM 102. A vendor may be any agency that offers products for sale, such as a bricks and mortar retailer, an online retailer, a manufacturer selling its products directly, or the like. Vendor mechanism 110 may include one or more mechanisms that enable a vendor to conduct and manage transactions with consumers and may enable the tracking of consumers via consumer identifiers. Vendor mechanism 110 may include one or more transactional mechanisms, such as a point-of-sale (POS) system mechanism (e.g., one or more POS terminals and any computing mechanisms necessary to run them), a shopper card system mechanism (e.g., a loyalty or membership mechanism), a coupon processing mechanism, or the like. For example, vendor mechanism 110 may log each of a consumer's transactions by storing the associated transactional data in reference to a consumer identifier (e.g., shopper card number) presented during the transaction. In some scenarios, a vendor may also manage a reward program and/or may be the program's sponsor or closely affiliated with the sponsor. In this case, rather than interact with RPM 102 directly, the vendor may employ sponsor mechanism 104 to do so.

Although RPM 102 and vendor mechanism 110 are typically described herein as separate mechanisms, this is not to be construed as limiting. In one embodiment, one entity or multiple, affiliated entities, may manage both RPM 102 and vendor mechanism 110 and, as such, RPM 102 and vendor mechanism 110 may be components of one transaction management mechanism. For example, one entity may provide shopper card management services (e.g., to track consumer loyalty and purchasing patterns) and reward program services (e.g., to track consumer reward program participation), thereby alleviating the need for the vendor to do so. This may be particularly appealing to a vendor who lacks the means or desire to manage a shopper reward system and/or reward program but wishes to offer such services to attract customers.

RPM 102 may also maintain beneficiary data for the participating beneficiary. Beneficiary data may include data indicative of the associated sponsor, such as program markers, and any data needed to ensure that beneficiary mechanism 110 may interact with RPM 102. Beneficiary data may include information necessary for benefit delivery, such as contact information (e.g., mailing address, email address, phone number, etc.), a financial account number, a reward account number, or the like. Additionally, beneficiary mechanism 106 may receive benefit data from RPM 102. Benefit data may include information indicative of any benefit due to a beneficiary, such as the type of benefit, the value and/or amount of the benefit, or the like. Beneficiary mechanism 106 may include a computer mechanism associated with the beneficiary that enables reward program processes. Beneficiary mechanism 106 may also maintain one or more elements of beneficiary data. For example, beneficiary mechanism 106 may be a financial institution mechanism, a reward point mechanism, a beneficiary-specific computer mechanism, or the like. For example, beneficiary data may include beneficiary financial account data so that the financial account may be credited according to reward program parameters, as indicated by received benefit data. In one scenario, the beneficiary may be provided with information regarding the consumer, such as contact information, demographic data, contribution values, or the like. This may enable the beneficiary to analyze data about program participants, communicate with consumers (e.g., to thank them), or the like.

As mentioned, the beneficiary may be the consumer and, as such, the consumer may be synonymous with the beneficiary and may be rewarded for his purchase behavior. For example, the consumer may receive a reward in a financial account, such as a reward point account, a stored value account, a savings account, or the like. As another example, a consumer may be rewarded for purchasing environmentally friendly products by receiving a credit to a reward account. The consumer may use the value stored in the reward account to obtain a discount on a subsequent purchase, to purchase special reward products (e.g., via a program Web site), or the like. As described in detail below, the consumer may receive a benefit in a reward account associated with a Web service, such as an Internet game provider. In one scenario, the beneficiary may receive the reward as an incentive redeemable with a vendor. For example, an incentive may be issued at a point-of-sale (e.g., printed or associated with the consumer's shopper card), or may be provided to the beneficiary via the Internet (e.g., accessible via email or at a Web site). In one embodiment, beneficiary mechanism 106 may be managed by the sponsor (e.g., it may be a reward mechanism designed specifically for the reward program). Beneficiary mechanism 106 may be a component of sponsor mechanism 104.

Alternatively, the beneficiary may be another individual (e.g., a consumer's child, a spouse, etc.). The beneficiary may be a charity, a non-profit organization, an educational organization, or the like. For example, a sponsor may contribute a cash value to a consumer-selected school whenever the consumer purchases a particular brand of breakfast cereal. In another embodiment, the beneficiary may be another type of entity, such as a for-profit entity (e.g., the consumer's employer), or any other entity.

The logical components identified in FIG. 1 are merely exemplary. Additional or alternate configurations of logical components that provide similar and/or additional functionality to that of the logical components in FIG. 1 may be used within the scope of this disclosure.

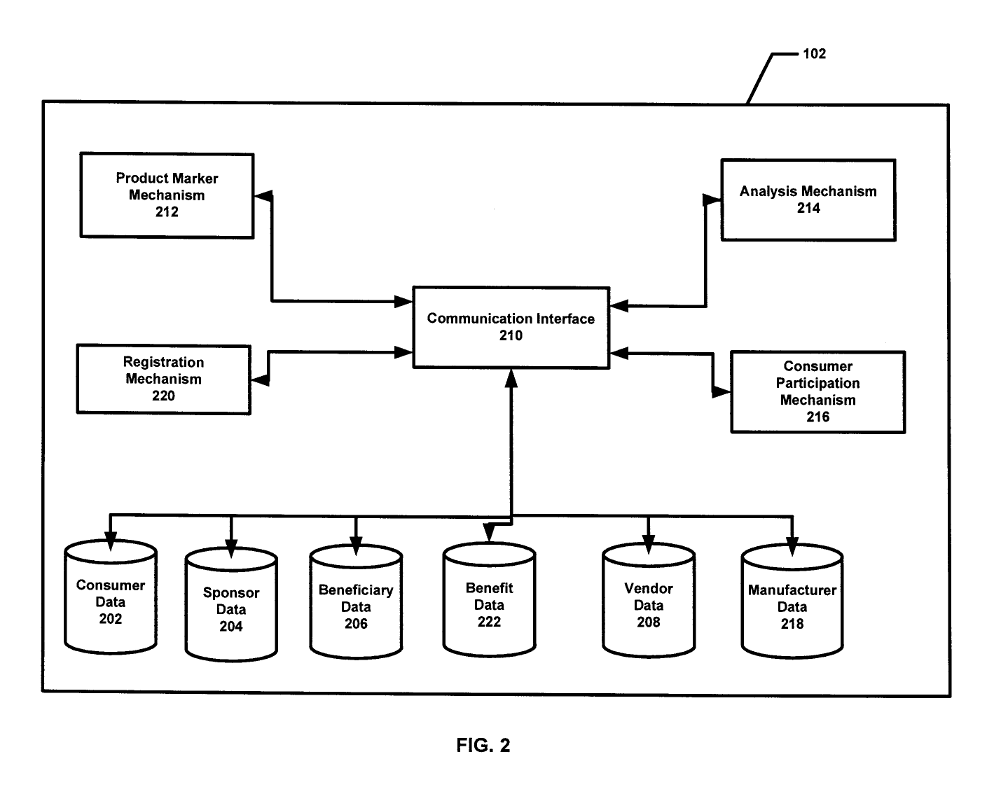

FIG. 2 illustrates an embodiment of an architecture overview of a reward program manager mechanism, such as RPM 102. As aforementioned, RPM 102 may include a computer processor and other electronic components, such as a server, a database, or the like, which may be necessary for its processes.

RPM 102 may include communication interface 210, which may facilitate the routing of data between various, internal components of RPM 102 and/or the routing of data between RPM 102 and one or more external components. For example, communication interface 210 may receive transactional data from vendor mechanism 110, receive reward program parameter data from sponsor mechanism 104, or transmit benefit data to beneficiary mechanism 106.

RPM 102 may maintain data associated with consumers, sponsors, beneficiaries, vendors, and manufacturers, such as consumer data 202, sponsor data 204, beneficiary data 206, benefit data 222, vendor data 208, and manufacturer data 218. For example, such data may be maintained in data tables, system accounts, or the like for each of the aforementioned entities. As a consumer may also be a beneficiary, consumer data 202 and beneficiary data 206 may be one in the same. Although the aforementioned data types are depicted as being maintained by RPM 102, this is not to be construed as limiting. In addition to, or instead of, being maintained by RPM 102, one or more of these data types may be maintained by another RPMS 100 component. For example, beneficiary data 206 may be maintained by beneficiary mechanism 106.

Product marker mechanism 212 may be configured to assign program markers to product identifiers received from sponsor mechanism 104 to ensure accurate tracking of products included in a reward program. In an alternate embodiment, vendor mechanism 110 may include a product marker mechanism and may associate a program identifier with consumer identifiers in its own records. In such a scenario, RPM 102 may route the product information from sponsor mechanism 104 to vendor mechanism 110. In one embodiment, product marker mechanism 212 may assign the same program marker to each product identifier associated with the reward program. In another embodiment, product marker mechanism 212 may assign different program markers to different product identifiers associated with the reward program, thereby enabling RPM 102 to differentiate between different benefits for various products included in the reward program (although the different program markers may still indicate the products are included in the same reward program). For example, a program marker may indicate benefit data, such as how many reward points a particular product is worth. A 20-ounce container of a soda product may be worth one reward point, while a liter container of the same soda product may be worth three reward points. In one scenario, a program marker may be assigned to a particular quantity of a certain product, rather than or in addition to being assigned to the product. For example, a program marker may be assigned to three units of a particular potato chip product. Such multi-product program markers may be only valid if a consumer purchases the designated product amount (e.g., either a certain quantity or a certain dollar value). In the aforementioned scenarios, the reward program parameter requirement check is inherent, thereby alleviating the need to determine whether a consumer has sufficiently participated. That is, transactional data may not be considered to have a participating product if it does not include the appropriate product amount or the benefit value need not be determined because it is indicated by the program marker itself.

In one embodiment, RPMS 100 may employ multiple markers for a program in a hierarchical manner. In addition to a program marker identifying a program, it may also include a sub-marker indicative of a particular benefit or requirement. For example, a cereal reward program may be identified with the program marker “CRPXYZ,” and the purchase of a product associated with that marker only, such as a standard-sized box of cereal, may indicate one point to a reward account. Products associated with the program marker and a sub-marker may result in a different reward. For example, extra large boxes of the cereal may additionally be marked with “123,” (i.e., CRPXYZ123), which may indicate those boxes result in the standard benefit plus an extra reward (e.g., an extra reward point), or an entirely new benefit.

Consumer participation mechanism 216 may associate program identifiers, such as program markers, with consumer identifiers so that RPM 102 may inform vendor mechanism 110 which consumers are participating in a particular reward program. In an alternate embodiment, vendor mechanism 110 may include a consumer participation mechanism and may associate a program identifier with consumer identifiers in its own records. RPM 102 may also share product identifier data and consumer identifier data with sponsor mechanism 104, beneficiary mechanism 106, and/or manufacturer mechanism 112. For example, RPM 102 may share data regarding which products a consumer purchased, consumer demographic data, consumer contact data, or the like. Such data may prove valuable to such entities, particularly for marketing purposes.

Analysis mechanism 214 may be configured to analyze transactional data received from vendor mechanism 110 to determine if it includes product data associated with a reward program. Analysis mechanism 214 also may be configured to evaluate transactional data in light of one or more parameters associated with a reward program, thereby determining if a beneficiary is due a reward and, if so, generating corresponding benefit data. Analysis mechanism 214 may determine which transactions associated with a consumer include a marked product identifier and may determine what reward is due to the beneficiary based upon the particulars of the transactions. For example, a reward may be issued based upon the quantity of product purchased, the time period in which it purchased, or the like. If a reward is warranted, analysis mechanism 214 may initiate the appropriate action (e.g., initiate a value transfer to beneficiary mechanism 106).

RPM 102 may also include registration mechanism 220, which may be configured to enable one or more of a consumer, a vendor, a sponsor, a beneficiary, and a manufacturer to register their respective data with RPM 102. For example, registration mechanism 220 may receive data from one of the aforementioned entities, such as via a Web site. Registration mechanism 220 may also enable one or more of the aforementioned entities to modify or supplement previously registered data.

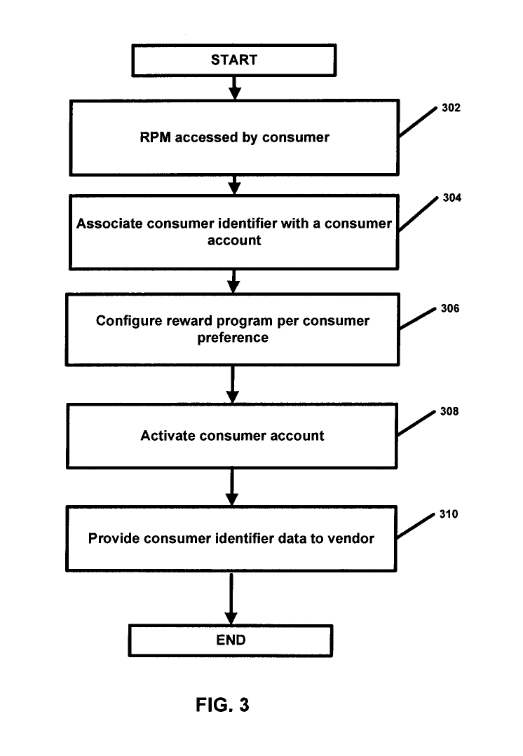

FIG. 3 depicts a flowchart of an embodiment of a process of a consumer registering with a reward program manager mechanism, such as RPM 102. A consumer may register his data by employing consumer access mechanism 108, such as a personal computer or mobile device, that enables the consumer to access RPM 102 (step 302). In one embodiment, RPM 102 may present consumer access mechanism 108 with a Web page configured to receive consumer data. Once the consumer has accessed RPM 102, the consumer may be prompted to provide registration information, which may be relayed to registration mechanism 220.

The consumer may provide one or more consumer identifiers, which are then associated with a consumer account (step 304). For example, a consumer may input a shopper card number (e.g., a Kroger card number, a Costco card number, etc.), a phone number, an identification number (e.g., a driver's license number), a financial account number (e.g., a credit card number), an email address, biometric data, (e.g., a fingerprint scan), or the like. Additionally, or alternatively, registration mechanism 220 may generate a consumer identifier and associate it with the consumer account. As mentioned above, this generated consumer identifier may or may not be provided to the consumer depending upon system implementation. A consumer identifier may be all that is needed for registration or, alternatively, the consumer may be required to register other data, such as contact information, demographic information, financial account information, or the like.

In one scenario, registration mechanism 220 may be enabled to retrieve consumer information from another data source. For example, a consumer may have previously registered for access to a reward program with a sponsor directly (e.g., at the sponsor's Web site). Registration mechanism 220 may interface with the data source and obtain consumer information from it instead of, or in addition to, obtaining it directly from the consumer. For example, registration mechanism 220 may transmit a consumer identifier to sponsor mechanism 104 or vendor mechanism 110 and that mechanism may employ the identifier to locate registered information. It may then transmit the registered information to registration mechanism 220 which may, in turn, store it in the appropriate consumer account.

Registration mechanism 220 may also configure the consumer account according to consumer-indicated preferences (step 306). In one scenario, a consumer may select one or more program categories related to the reward program. A consumer's product category selection may provide one or more of the participating parties with data regarding a consumer's likes and dislikes, limit which purchased products reward a beneficiary, enable extra rewards (e.g., a beneficiary may receive an extra reward if the consumer purchases products from a selected category), or the like. For example, a consumer may be prompted to specify up to three product types that he purchases most frequently, such as breakfast foods, paper products, pharmaceuticals, or the like. Level requirements may be associated with a product category and a consumer may indicate the level at which he will participate, with the higher level granting greater benefits. For example, a consumer may be allowed to indicate whether he is willing to purchase three, five or ten products from a program category for a benefit, with the benefit being greater if the consumer opts to purchase a higher quantity.

A consumer may select one or more vendors with which to participate in the reward program. For example, a reward program may be valid at more than one vendor. Accordingly, the consumer may select each participating vendor with which he normally transacts. A consumer may register a separate consumer identifier for each vendor or may employ the same customer identifier at more than one vendor. For example, a consumer may enroll a corresponding shopper card number for each vendor. Alternately, the consumer may enroll a credit card number and employ that credit card at each participating vendor in order to obtain the benefits of the program. The consumer may also select the particular beneficiary to whom he wishes to contribute.

If RPM 102 is configured to offer more than one reward program conjointly, the consumer may select multiple reward programs in which to participate. A consumer may be enabled to configure how much value is to be sent to various beneficiaries and/or reward programs. For example, a consumer may be allowed to determine the percentage of the benefit that is to be provided to the beneficiary. In one scenario, if RPMS 100 is implemented to enable multiple reward programs and a particular product is associated with more than one reward program, the consumer may need to select a single reward program for that product or may be enabled to determine a percentage for each reward program. Alternatively, each beneficiary may receive the full benefit for each reward program.

If RPM 102 is enabled to manage more than one reward program conjointly, once a consumer has selected a reward program, registration mechanism 220 may instruct consumer participation mechanism 216 to associate a corresponding program marker with the consumer account. This enables the consumer account to be referenced in regard to the reward program in which the consumer has elected to participate. As aforementioned, in one embodiment, vendor mechanism 110 may include a consumer participation mechanism and may handle this association. The program marker may be used as a program identifier to distinguish the consumer's data from other reward programs (if any) maintained by RPM 102. If the particular implementation of RPMS 100 pertains to only one reward program, all consumer data 202 may pertain to a single reward program.

Once the consumer has provided sufficient information and configured his reward program preferences (if any), registration mechanism 220 may activate his consumer account, thereby enabling the consumer to participate in the reward program (step 308).

RPM 102 may provide consumer identifier data to vendor mechanism 110 so that vendor mechanism 110 may maintain a record of which consumer identifiers are associated with the reward program (step 310). RPM 102 may determine which consumers are associated with the vendor by determining if a registered consumer identifier is associated with vendor mechanism 110. If vendor mechanism 110 includes a consumer participation mechanism, it may associate the consumer identifiers with a program marker.

RPM 102 may provide such data in a periodic batch (e.g., providing the consumer identifiers of multiple consumers once a threshold is met or a deadline is reached), may provide such data in real time or near-to-real time (e.g., immediately after a consumer has registered), or the like. If RPM 102 and/or if vendor mechanism 110 is configured to handle multiple reward programs, the consumer identifier data may include one or more program identifiers, such as program markers, so vendor mechanism 110 may determine the reward program(s) associated with the provided consumer identifier data. Conversely, if RPM 102 is configured to manage only one reward program or if vendor mechanism 110 is only participating in one reward program, the consumer identifier data provided need not indicate a particular reward program (i.e., vendor mechanism 110 may inherently recognize that the data is for the particular reward program because it is not receiving data concerning another reward program).

The consumer need not access his consumer account again, unless he wishes to modify his registered information (e.g., change reward program configuration), review the status of his rewards (e.g., determine what reward he has earned), obtain a reward (e.g., redeem reward points), or the like. A consumer may access RPM 102 to participate in a supplemental, electronic promotion associated with the reward program.

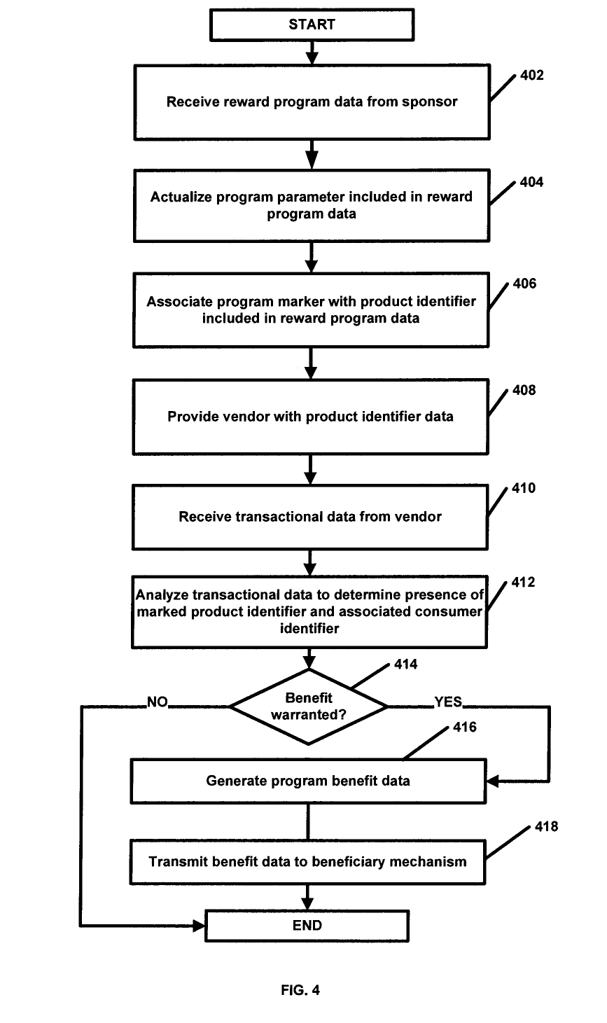

FIG. 4 depicts a flowchart of an exemplary process in which a reward program manager mechanism, such as RPM 102, manages a reward program. Although the following operations may transpire sequentially, the particular timing of each operation may vary. In some scenarios, one or more operations may follow immediately after the other and, in other cases, certain operations, such as those involving the transmission of data, may occur at periodic times, such as in batch transmissions.

Communication interface 210 may receive reward program data from a sponsor (step 402). This transmission may include data for the initial setup of a reward program or for an update to an existing reward program. The reward program data may identify one or more beneficiaries and may include product identifiers for products to be included in the reward program. A product identifier includes data that identifies a particular product. A product identifier may include alphanumeric data (e.g., a product name), a product item number or code [e.g., a UPC, a stock-keeping unit (SKU) number, a Global Trade Item Number (GTIN), a European Article Number (EAN), etc.], or the like, thereby enabling components of RPMS 100 to readily reference and identify the associated product. For example, the reward program may include a potato chip product and the product identifier may be its UPC. The reward program data may also include reward program parameter data, which may indicate one or more provisions for the reward program, such as requirements that need to be met in order for a beneficiary to benefit from a consumer's transaction and/or the amount of benefit a beneficiary is to receive. For example, a program parameter may indicate the quantity of a product that a consumer must purchase in order for a beneficiary to receive a benefit. Alternately, a program parameter may indicate a portion of the sales price of a product to be used as the basis for the benefit. A program parameter may also indicate the particular benefit associated with a specific product identifier.

If the received reward program data includes one or more program parameters (e.g., new parameters or updates to previously received ones), RPM 102 may actualize the parameters in analysis mechanism 214 (step 404). If RPM 102 is configured to manage multiple reward programs, a reward program parameter may be referenced by a program identifier, such as a program marker. This step may be omitted if the received reward program data does not include new program parameters (e.g., if the received data simply modifies which products are included in the reward program, but not the parameters that need to be met).

If the received reward program data includes one or more product identifiers, product marker mechanism 212 may associate each product identifier with a program marker (step 406). A program marker associates the product with the appropriate reward program. For example, the potato chip product's UPC may be associated with the reward program and, once product marker mechanism 212 marks the UPC, any component of RPMS 100 may readily ascertain as much. If RPM 102 is implemented to manage a plurality of reward programs, product marker mechanism 212 may maintain a program marker for each reward program. A product identifier may be associated with more than one product marker if one or more programs employ the same product identifier for the same product. For instance, the potato chip product's UPC may be associated with both a reward program for consumer reward points and a reward program for a breast cancer awareness beneficiary. As aforementioned, a program marker may inherently indicate a reward program parameter. For example, a program marker may be associated with a particular product quantity or dollar value, and a product only may be considered a participating product if the consumer purchases the necessary quantity or value. Additionally, or alternatively, a program marker may indicate a specific benefit for the associated product (e.g., the value of the benefit due).

Communication interface 210 may provide vendor mechanism 110 with the marked product identifier data for consumers that are associated with the vendor (step 408). As aforementioned, this transmission may occur on a periodic basis. Vendor mechanism 110 may log which products are included in the particular reward program in reference to the program marker. If the provided product identifier data is an update, vendor mechanism 110, may access the associated reward program data and update its records. As described below, vendor mechanism 110 may use this data to determine which of its consumers have purchased products associated with a reward program. Communication interface 210 may determine which products are associated with the vendor via product identifiers registered in vendor mechanism 110.

In one embodiment, product identifier data is provided as a registry listing product identifiers included in the reward program. In another embodiment, product identifier data is provided to vendor mechanism 110 in real time or near-to real time.

RPM 102 may receive transactional data from vendor mechanism 110 (step 410). The transmittal of transactional data from vendor mechanism 110 to RPM 102 may occur in various manners and at various times. In one embodiment, transactional data may be relayed during a transaction (i.e., in real time or in near-to real time), in a daily or weekly batch transfer (e.g., at the end of a business day or week), or the like.

The content of the received transactional data may vary dependent upon the data vendor mechanism 110 previously received from RPM 102. If vendor mechanism 110 received both marked product identifier data and consumer identifier data, it may analyze transactional data to determine whether it contains consumer identifiers associated with marked product identifier data. Vendor mechanism 110 may filter the transactional data to eliminate non-participating consumers and products and transmit the filtered transactional data to RPM 102. In one embodiment, vendor mechanism 110 may provide RPM 102 with all transactional data that it has processed since the time of its last data transmittal to RPM 102. Such an embodiment may transfer responsibility of analyzing data from vendor mechanism 110 to RPM 102 completely, enabling a vendor to provide consumers with the benefits of such programs without allocating internal resources to such efforts. In another embodiment, if vendor mechanism 110 has at least received consumer identifier data from RPM 102, the transmitted transactional data may include information regarding consumers confirmed as being registered with RPM 102. Vendor mechanism 110 may analyze the transactional data it has stored and determine which transactions involved a consumer identifier provided by RPM 102 and transmit only the associated transactional data to RPM 102. In another embodiment, if vendor mechanism 110 received at least marked product identifier data, the vendor mechanism may analyze the transactional data it has stored, determine which transactions involved a marked product identifier, and transmit only the associated transactional data to RPM 102.

Vendor mechanism 110 may compare the product identifiers of a transaction with a record of participating product identifiers and omit transactions not associated with a participating product. For example, vendor mechanism 110 may store transactional data from a purchase and determine if any of the items a consumer purchased are associated with a marked product identifier. If one or more purchased items are associated with a marked product identifier, vendor mechanism 110 may associate the marked product identifier with the consumer identifier that the consumer presented during the transaction (e.g., his shopper card number). This filtered data may then be transmitted to RPM 102.

In an alternate embodiment, vendor mechanism 110 may include a product marker mechanism and may handle the association of product identifiers with program markers. As such, communication interface 210 may provide vendor mechanism 110 with unmarked product identifier data. In one scenario, vendor mechanism 110 may add a tracking code to product identifier data to ease processing by vendor mechanism 110 and/or RPM 102. The tracking code may be used in addition to a program marker or serve as a program marker itself. For example, the tracking code may serve as the program maker and, because vendor mechanism 110 may handle the association of the tracking code with the product identifier data, step 406 may be performed by vendor mechanism 110. In one embodiment, vendor mechanism 110 includes a coupon processing mechanism that may be utilized to aid processing of the tracking code. For example, the tracking code may be in a coupon code format, thereby enabling vendor mechanism 110 to handle the product identifier data as it would a coupon code, albeit it typically one with no value (i.e., as a “zero-value” coupon). During a transaction with vendor mechanism 110, the consumer may not receive a discount for the associated product, but the transaction may be marked with the zero-value coupon tracking code, thereby indicating that the transaction includes a marked product identifier. When transactional data is analyzed by the coupon processing mechanism of vendor mechanism 110 (e.g., to extract data regarding coupon redemption), the coupon processing mechanism may log the products and/or transactions associated with a tracking code, thereby providing the vendor mechanism 110 with a convenient manner in which to determine which transactions involved a reward program product. Vendor mechanism 110 may then transmit to RPM 102 transactional data associated with a tracking code for benefit processing. Alternatively, vendor mechanism 110 may transmit all transactional data or transactional data only associated with participating consumer identifiers, and RPM 102 may extract product identifiers associated with a tracking code.

The amount of information provided in the transmitted transactional data may vary according to a particular implementation. The data may be detailed and include one or more particulars of a consumer's transactions (e.g., the exact products purchased, the cost of the products, etc.) or may include only data RPM 102 requires for accurate reward program accounting (e.g., the data may simply indicate the quantity of participating products that a consumer purchased and indicate which consumer made the purchase).

Vendor mechanism 110 may provide transactional data to communication interface 210, which may relay the transactional data to analysis mechanism 214. Analysis mechanism 214 may examine the received transactional data to determine if it includes a product identifier associated with a program marker and, if so, with which consumer identifier it is associated (step 412). If the received transactional data was not filtered by vendor mechanism 110 or only partially filtered, analysis mechanism 214 may filter data based on one or more of consumer identifiers and product identifiers. For example, analysis mechanism 214 may determine the presence of product identifiers and/or tracking codes, compare the transactional data with a registry of participating products, or the like. Analysis mechanism 214 may then analyze the relevant transactional data (i.e., data that includes a product identifier associated with a program marker). If vendor mechanism 110 sufficiently filtered the transactional data before transmitting it to RPM 102, analysis mechanism 214 need not analyze the transactional data in this regard (i.e., step 412 may be omitted).

Regardless of the manner in which transactional data is handled, once it reaches RPM 102, RPM 102 may store any or all elements of the data. This may be advantageous if RPM 102 wishes to share consumer or purchase data with, for example, a manufacturer, even if the particular elements of the data to be shared have no direct relation to reward program processes. For example, a particular consumer's purchase data may be stored in association with his consumer account.

Analysis mechanism 214 may analyze the relevant transactional data in order to determine if a benefit is warranted (step 414). In one embodiment, analysis mechanism 214 may analyze the transactional data in regard to one or more parameters associated with the reward program to determine if the parameter(s) are met. For example, analysis mechanism 214 may determine if a consumer purchased a sufficient amount of product or paid a sufficient dollar value. In another embodiment, a program marker associated with the product identifier may indicate whether a benefit is warranted. For example, a marked product identifier may only be included in the transactional data if the consumer purchased the appropriate product quantity or dollar amount.

If a benefit is warranted, analysis mechanism 214 may generate benefit data indicative of the appropriate program benefit (step 416). Analysis mechanism 214 may determine which consumer identifier is associated with the relevant transactional data in order to accomplish this. If the reward program is designed to provide a reward based on a product's price, analysis mechanism 214 may determine the amount to be provided and initiate the reward. For example, if 1% of the purchase price is to be provided as a reward, analysis mechanism 214 may determine the price paid (e.g., $5.00) and initiate the appropriate reward (e.g., 1% of $5.00 is $0.05). If the program marker indicates a particular reward for the associated product, analysis mechanism 214 may provide the appropriate reward. For example, if a program marker indicates particular product is worth one reward point, analysis mechanism 214 may initiate the awarding of this reward point. Communication interface 210 may transmit the benefit data to beneficiary mechanism 106 (step 418). Beneficiary mechanism 106 may then reward the beneficiary accordingly.

The time at which the benefit determination occurs may depend upon when RPM 102 receives transactional data from vendor mechanism 110. For example, if RPM 102 receives the transactional data prior to the completion of the transaction, analysis mechanism 214 may initiate beneficiary determination procedures instantly, and the results may be conferred to vendor mechanism 110. Vendor mechanism 110 may then inform the consumer of such results, such as via a display screen at a point-of-sale or on information included with a sales receipt.

In one embodiment, in addition to employing transactional data for benefit determination, RPM 102 may use transactional data to enable reporting functionalities for one or more parties participating in RPMS 100, such as the entities managing RPM 102, sponsor mechanism 104, beneficiary mechanism 106, vendor mechanism 110, and/or manufacturer mechanism 112. The reporting data provided may be based on the transactional data received by RPM 102 and may contain one or more elements of the information included in such data. The reporting data provided may be raw data or may be data that has been generated after analysis by RPM 102. The recipient of the reporting data may analyze the information as well. For example, reporting data may include information regarding where and/or when consumers shop, which products they buy, purchase quantity, purchase frequency, and the like. A vendor or manufacturer may use such data to enhance its warehousing, advertising and/or marketing procedures. Furthermore, reporting data may include consumer identifiers. Consumer account data which may be relayed to the participating party for analysis as well. This may allow the participating party to analyze consumer demographic data, contact information, or the like.

Any participating party, including the entity operating RPM 102, may employ transactional data to encourage greater consumer use of RPMS 100. RPM 102, or any entity or system component granted sufficient access, may analyze transactional data to determine if any of a consumer's transactions indicate he has purchased a product that is involved in a reward program in which the consumer is not enrolled. RPM 102 may communicate with the consumer, such as by sending him an email, displaying a message with his transaction receipt, or displaying a notification when he accesses his consumer account, informing him of this reward program and indicating the benefit he would receive if he participated. As mentioned, transactional data may be made available to other entities, and, for example, a sponsor or manufacturer may use such data to contact consumers that purchase reward program products but have not enrolled in the corresponding reward program. Additionally, RPM 102, or another RPMS 100 component or managing entity, may contact consumers who are enrolled in its reward program but have purchased one or more competing products and suggest that the consumers purchase its product instead to obtain greater benefit from the program in which they are enrolled. For example, the sponsor of one program may determine that a consumer has purchased a competitor's product instead of a product participating within its program. The consumer may be informed, either via RPM 102 or another RPMS 100 entity, that he would have contributed to the beneficiary if he had purchased the sponsor's product and suggest he do so next time.

In one embodiment, sponsor mechanism 104 may be a Web service. For example, RPMS 100 may interact with a social networking service, such as Facebook or MySpace, or entities that participate with such services, such as Zynga Game Network, Inc. In one particular scenario, RPMS 100 may enable a consumer to participate in functionality included in a social Internet game offered by the sponsor, such as Farmville. A consumer may enroll in the game via RPM 102 or sponsor mechanism 104. Additionally, if the game is associated with a particular vendor, sponsor, beneficiary, and/or manufacturer, a consumer may enroll via vendor mechanism 110, beneficiary mechanism 106, or manufacturer mechanism 112, respectively. When a consumer enrolls in the game, he may register a consumer identifier, such as a shopper card number. If the consumer is already a player, he may modify his game account to include the necessary consumer identifier or, if he has previously provided it (e.g., his game account already includes an appropriate consumer identifier), he may activate his game account for participation in RPMS 100. As previously mentioned, the consumer identifier may be used as a reference in RPMS 100, enabling all parties to identify the consumer in their respective mechanisms. When the consumer purchases one or more particular products with a vendor, these may be recorded by vendor mechanism 110 and included in the transactional data it transmits to RPM 102. RPM 102 may analyze the received transactional data. As aforementioned, a beneficiary may be the consumer himself, and RPM 102 may provide a benefit to the consumer via his game account. For example, a consumer may receive a game value which he may spend for in-game products (e.g., a Farmville gamer may receive bonus Farm Cash or Farm Coins).

In one embodiment, a consumer may access RPM 102 to participate in a supplemental, electronic promotion associated with the reward program managed via RPMS 100. In one scenario, a consumer may select a bonus promotion that, once selected, is associated with his consumer identifier. This may enable the consumer to generate an additional benefit in addition to the typical reward provided by the reward program. For example, the consumer may generate a typical benefit for purchasing a particular product. If the consumer accesses his account and selects a bonus promotion for the same product, RPM 102 may associate a bonus promotion marker with his account. When the consumer purchases the product and RPM 102 receives the associated transactional data, it may award the beneficiary the typical benefit and the bonus benefit. Another bonus promotion procedure may enable a consumer to enter a promotional code while accessing his consumer account. The promotional code may be provided by a vendor, manufacturer, or the like. Once the promotional code is entered, the beneficiary may receive a benefit in addition to any typical one it is due. Bonus promotion procedures may encourage a consumer to enroll in the electronic version of a reward program as it may enable the consumer to generate more benefits than he would via the traditional program.

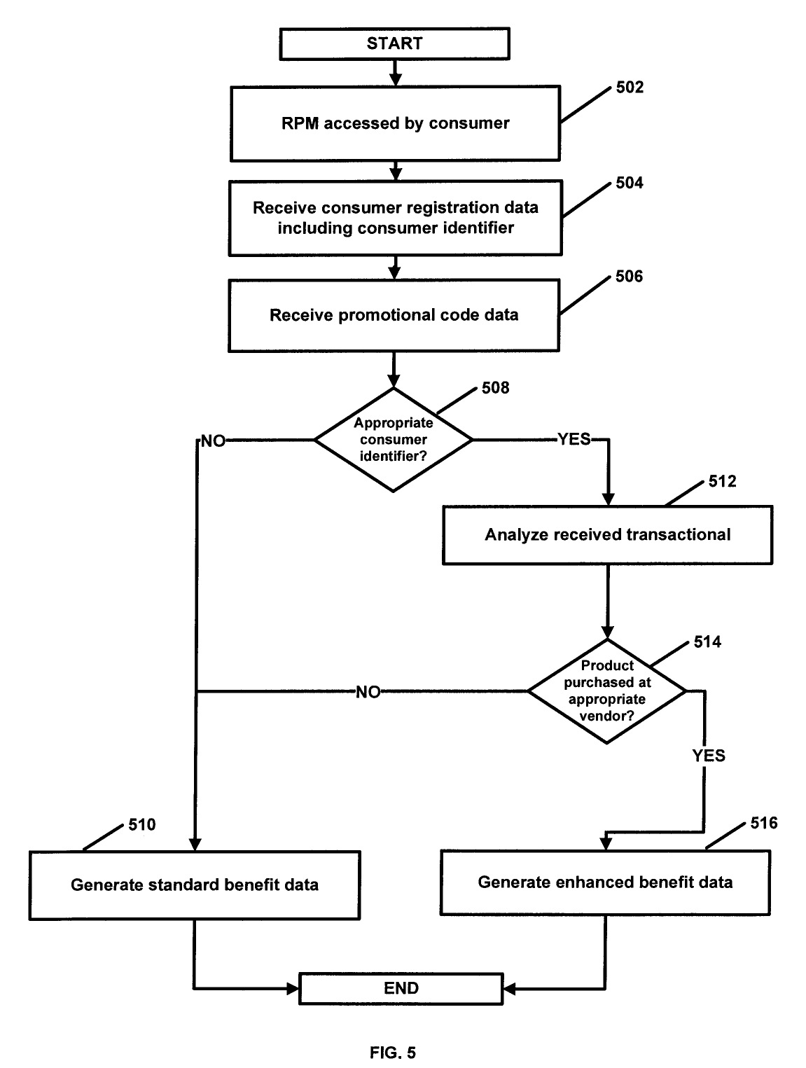

One embodiment of a promotional code procedure is described in relation to FIG. 5. As depicted by FIG. 5, a reward program manager mechanism, such as RPM 102, may manage a promotional code reward program enhanced by use of a consumer identifier. A reward program may involve the use of promotional codes, which may include alphanumeric data included on a product's packaging (e.g., on a label, bottle cap, etc.). In order to participate, a consumer may access his consumer account at RPM 102 via consumer access mechanism 108 (step 502). For example, a consumer may access a reward program Web page. If he has not already registered, the consumer may enter registration data, including a consumer identifier, and RPM 102 may receive this data and associate it with a consumer account (step 504). If the consumer registered previously, he need not provide this information again (i.e., step 504 may be omitted). The consumer identifier may be associated with a particular vendor (e.g., a shopper card number). The registration process may be similar to the process described in relation to FIG. 3 and may be omitted if the consumer has previously registered. A consumer need not register a consumer identifier to participate in the standard form of the promotional code reward program, but may do so if he wishes to enhance the benefit obtained via the reward program. Because the enhanced program may be associated with a particular vendor, it may encourage the consumer to shop at that vendor instead of a competitor.

The consumer may provide RPM 102 with promotional code data associated with a product he has purchased (step 506). For example, a consumer may type in a promotional code found on a bottle cap into a data field on a Web page. RPM 102 may determine if the consumer has registered the appropriate consumer identifier associated with an enhanced benefit (e.g., the appropriate shopper card number) (step 508). If the consumer has not registered the appropriate consumer identifier, RPM 102 may generate the standard benefit data and beneficiary mechanism 106 may provide the standard benefit to the beneficiary (step 510). If the consumer has registered the appropriate consumer identifier, RPM 102 may analyze transactional data it has received from a vendor mechanism 110 to determine if it contains data associated with the consumer identifier that includes a product identifier marked with a program marker for the promotional code reward program (step 512). By doing so, RPM 102 may determine if the consumer purchased the participating product at the appropriate vendor (step 514). If not, RPM 102 may provide the standard benefit (step 510). If so, RPM 102 may generate benefit data including the enhanced benefit, and the beneficiary mechanism 106 may provide an enhanced benefit, such as the standard benefit with an additional bonus reward, to the beneficiary (step 516). As described in relation to FIG. 4, a beneficiary may only receive a standard and/or enhanced benefit if a necessary reward program parameter has been met.

Although RPMS 100 has been described mainly in terms of a consumer reward program, this is not to be construed as limiting. RPM 102 may manage a reward program meant to benefit an entity other than a consumer. For example, the reward program may be a school reward program (e.g., Campbell's “Labels for Education”), a religious reward program (e.g., donations are provided to a church), a medical-related or health-related program (e.g., the Susan G. Komen for the Cure, the Red Cross, etc.), a community outreach program (e.g., the United Way), a youth outreach program (e.g., the Boys & Girls Clubs of America), an environmental (e.g., a “green”) program, or the like.

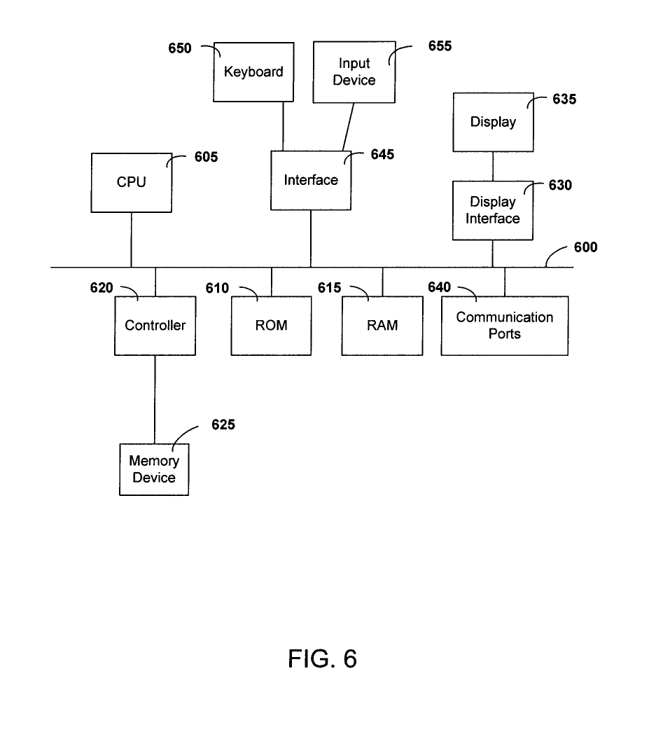

FIG. 6 depicts a block diagram of exemplary internal hardware that may be used to contain or implement program instructions, such as the process steps discussed above in reference to FIGS. 3 to 5, according to embodiments. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an exemplary processing device, computing device, processor or mechanism as such terms are used within this disclosure. Read only memory (ROM) 610 and random access memory (RAM) 615 constitute exemplary memory devices (i.e., processor-readable non-transitory storage media).

A controller 620 interfaces with one or more optional memory devices 625 to the system bus 600. These memory devices 625 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 630 may permit information from the bus 600 to be displayed on the display 635 in audio, visual, graphic or alphanumeric format. Communication with external devices, such as a print device, may occur using various communication ports 640. An exemplary communication port 640 may be attached to a communications network, such as the Internet or an intranet.

The hardware may also include an interface 645 which allows for receipt of data from input devices such as a keyboard 650 or other input device 655 such as a mouse, a joystick, a touch screen, a remote control, a pointing device, a video input device and/or an audio input device.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the above description should not be considered to be exclusive of these other embodiments. Also, it is to be understood that the phraseology and terminology employed herein are for the purposes of description and should not be regarded as limiting.

Terminology used in the foregoing description is for the purpose of describing the particular versions or embodiments only, and is not intended to limit the scope of the present invention that will be limited only by the appended embodiments. As used herein and in the appended embodiments, the singular forms “a,” “an,” and “the” include plural references unless the context clearly dictates otherwise. Similarly, the words “include,” “includes” and “including” when used herein shall be deemed in each case to be followed by the words “without limitation.” Unless defined otherwise herein, all technical and scientific terms used herein have the same meanings as commonly understood by one of ordinary skill in the art. All publications mentioned herein are incorporated by reference. Nothing herein is to be construed as an admission that the embodiments disclosed herein are not entitled to antedate such disclosure by virtue of prior invention. Thus, various modifications, additions and substitutions and the like may be made without departing from the spirit of the invention and these are therefore considered to be within the scope of the invention as defined in the following embodiments.

What is claimed is:

1. A system for managing a proof of purchase reward program, the system configured to:
facilitate transmission of data received from one or more of a vendor mechanism, a reward program sponsor mechanism, a beneficiary mechanism, and a consumer access mechanism;
manage one or more of consumer data, reward program sponsor data, product data, beneficiary data, benefit data, vendor data, and reward program data, wherein the reward program data at least comprises a reward program parameter;
determine whether transactional data containing a consumer identifier complies with the reward program parameter; and
provide the beneficiary mechanism with benefit data if the transactional data containing the consumer identifier complies with the reward program parameter, thereby enabling the beneficiary mechanism to provide a beneficiary with a benefit identified by the benefit data.

2. The system of claim 1, wherein the beneficiary is a consumer associated with the consumer identifier.

3. The system of claim 1, wherein the system is managed by a product manufacturer.

4. The system of claim 1, wherein the system is further configured to facilitate transmission of data received from a manufacturer mechanism.

5. The system of claim 1, wherein the system is further configured to administer a transaction conducted between a vendor and a consumer.

6. The system of claim 1, wherein the system is further configured to manage the association of a program marker with product data, wherein the program marker associates the product data with the reward program.

7. The system of claim 1, wherein the system is further configured to manage the analysis of transactional data, wherein the analysis of transactional data comprises determining the presence of a consumer identifier associated with product data marked with a program marker.

8. The system of claim 7, wherein the analysis is performed via the vendor mechanism.

9. The system of claim 1, wherein the system is configured to facilitate the managing operations and the providing operation for a plurality of reward programs.

10. The system of claim 1, wherein the reward program parameter comprises requiring the presence of a consumer identifier associated with product data for a product included in the reward program.

11. A method for managing a proof of purchase reward system, the method comprising:
receiving transactional data, wherein the transactional data was gathered from a transaction occurring at a vendor system;
analyzing the transactional data, comprising:
identifying a consumer identifier associated with a consumer participating in the transaction and a product identifier associated with a product in the transactional data,
identifying the consumer as a participating consumer in response to the consumer identifier matching one of a plurality of consumer identifiers associated with a reward program, and
identifying the product as a reward program product in response to the product identifier associated with the product being associated with the reward program;
in response to identifying a reward program product and a participating consumer in the transactional data, determining a benefit due to a beneficiary in response to the transaction satisfying a reward program parameter; and
issuing a reward to the beneficiary in response to the reward program parameter being satisfied.

12. The method of claim 11, wherein the beneficiary is the participating consumer.

13. The method of claim 11, wherein analyzing the transactional data comprises analyzing the transactional data via the vendor system.

14. The method of claim 11, wherein analyzing the transactional data comprises analyzing the transactional data via a reward program manager mechanism.

15. The method of claim 11, wherein a product identifier includes one or more of a product name and a product item number.

16. The method of claim 11, wherein a consumer identifier is one or more of a shopper card number, a financial account number, a phone number, an identification number, biometric data, and an email address.

17. The method of claim 11, wherein issuing a reward comprises one or more of crediting a reward point account associated with the beneficiary, crediting a financial account associated with the beneficiary, and issuing an incentive to the beneficiary.

18. A method for an electronic proof of purchase reward program, the method comprising:
receiving, at a vendor system from a reward program manager mechanism, reward program data including a product identifier for a product included in a reward program;
creating, at the vendor system, a tracking code for the product identifier, wherein the tracking code enables a transactional mechanism of the vendor system to mark the product as a reward program product during a transaction;
identifying the reward program product during a transaction at the transactional mechanism, wherein identifying the reward program product comprises detecting the presence of a product identifier associated with the reward program;
marking the product identifier with a tracking code at the transactional mechanism;
storing transactional data associated with the transaction, wherein the transactional data includes the product identifier marked with the tracking code;
filtering the stored transactional data, wherein the filtering includes extracting transactional data associated with the tracking code; and
transmitting the filtered transactional data to the reward program manager mechanism, wherein the reward program manger mechanism is enabled to reward a beneficiary based upon the filtered transactional data.

19. The method of claim 18, wherein the tracking code is generated in the form of a coupon code.

20. The method of claim 19, wherein filtering the stored transactional data occurs contemporaneously with the coupon code processing of the vendor system.
